(19) United States
(12) Patent Application Publication
(10) Pub. No.: US 2016/0047703 A1
(43) Pub. Date: Feb. 18, 2016

(54) APPARATUS FOR MEASURING TORQUE OF MOTOR

(71) Applicant: HYUNDAI MOTOR COMPANY, Seoul (KR)

(72) Inventor: Dong Hyun Ha, Seoul (KR)

(21) Appl. No.: 14/569,548

(22) Filed: Dec. 12, 2014

(30) Foreign Application Priority Data
Aug. 12, 2014 (KR) 10-2014-0104327

(51) Int. Cl. G01L 3/10; H02J 5/00

(52) U.S. Cl. CPC G01L 3/105; H02J 5/005

(57) ABSTRACT

An apparatus for measuring torque of a motor includes: a shaft provided in a rotor of the motor and having an opening, a strain gauge inserted into the opening of the shaft and configured to measure torque of the motor, a transmitter in communication with the strain gauge, and a receiver in communication with the transmitter and configured to receive power from a vehicle.

### CROSS-REFERENCE TO RELATED APPLICATION

This application claims the benefit of and priority to Korean Patent Application No. 10-2014-0104327, filed on Aug. 12, 2014 in the Korean Intellectual Property Office, the disclosure of which is incorporated herein in its entirety by reference.

### TECHNICAL FIELD

The present disclosure relates to an apparatus for measuring torque of a motor, and more particularly, to an apparatus for accurately measuring torque of an electric motor of a vehicle to estimate a lifespan of a motor shaft.

### BACKGROUND

With respect to motor vehicles, a rotational object (or a body of rotation), such as a motor, is an element comprised of several machines intended for transmission of power (e.g., a rotational shaft of a vehicle or a shaft of a machine tool), and is subjected to a load of torque. In order to effectively transmit power of a rotational object, torque must be accurately measured.

As illustrated in FIG. 1, in a conventional apparatus for measuring torque of a motor, a slip ring 21 corresponding to an upper brush 11 is installed via an installation ring 20 on one side of a rotational shaft 10 such that both ends thereof protrude outwardly. A plurality of bearings B is installed within a cover 12 coupled to a housing 1 having a predetermined size. And a strain gauge 31 for sensing a fine mechanical change of the rotational shaft 10 and for detecting a corresponding electrical signal is installed on one side of the slip ring 21. The slip ring 21 should be press-fit to be coupled to and installed in the installation ring 20 in accordance with a length of a portion of the rotational shaft 10. Meanwhile, the strain gauge 31 should be installed in a gauge installation unit 30 formed at another portion of the rotational shaft 10 where the slip ring 21 is installed, thereby increasing the size of the housing 100 of the torque sensor A to accommodate those components.

Thus, a conventional apparatus for measuring torque cannot accurately measure torque because the slip ring 21 has a limited lifespan, and excess signal noise is generated due to contact. Meanwhile, torque measurement data may be transmitted and received using Bluetooth, but sensor precision is low, and excess signal noise is again generated due to interference caused by adjacent objects and various electric waves, thereby degrading the overall accuracy of torque measurement.

### RELATED ART DOCUMENT

Patent 1: Korean Utility Model Registration No. 20-0391558

### SUMMARY

The present disclosure has been made to solve the above-mentioned problems occurring in the related art, while advantages achieved by the related art are maintained intact.

An aspect of the present disclosure provides an apparatus for capable of accurately measuring torque of an electric motor for a vehicle to estimate a lifespan of a motor shaft.

According to embodiments of the present disclosure, an apparatus for measuring torque of a motor includes: a shaft provided in a rotor inserted into an interior of a motor and having an opening; a strain gauge inserted into the opening of the shaft and configured to measure torque of the motor; a transmitter in communication with the strain gauge; and a receiver in communication with the transmitter and configured to receive power from a vehicle.

The strain gauge and the transmitter may be connected via a wire.

The transmitter and the receiver may be inserted in a housing case of the motor.

The transmitter may be provided in one end of the housing case, and the receiver may be provided in the other end of the housing case.

The receiver may include: a power supply configured to supply power from the vehicle; a first coil connected to the power supply and configured to generate a magnetic field; a second coil spaced apart from the first coil by a predetermined distance and configured to generate an induced electromotive force; and a rectifier and regulator connected to the second coil and configured to supply a voltage.

The transmitter and the rectifier and regulator may be connected via a cable, allowing rectified power to be supplied to the transmitter.

The first coil may have a reception antenna configured to sense power supplied from the power supply.

The first coil and the second coil may be spaced apart from one another by a distance ranging from approximately 1 to 3 mm.

The housing case may be coupled to the shaft using a T-shaped fixing pin.

The housing case may have an O-ring rubber seal and may be assembled using a hexagonal bolt.

Furthermore, according to embodiments of the present disclosure, an apparatus for measuring torque of a motor includes: a shaft provided in a rotor of the motor and having an opening; a strain gauge inserted into the opening of the shaft and configured to measure torque of the motor; a transmitter in communication with the strain gauge and connected to the strain gauge via a wire; and a receiver in communication with the transmitter and including i) a power supply configured to supply power from a vehicle, ii) a first coil connected to the power supply and configured to generate a magnetic field, iii) a second coil spaced apart from the first coil by a predetermined distance and configured to generate an induced electromotive force, and iv) a rectifier and regulator connected to the second coil and configured to supply a voltage.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a conventional apparatus for measuring torque of a motor;

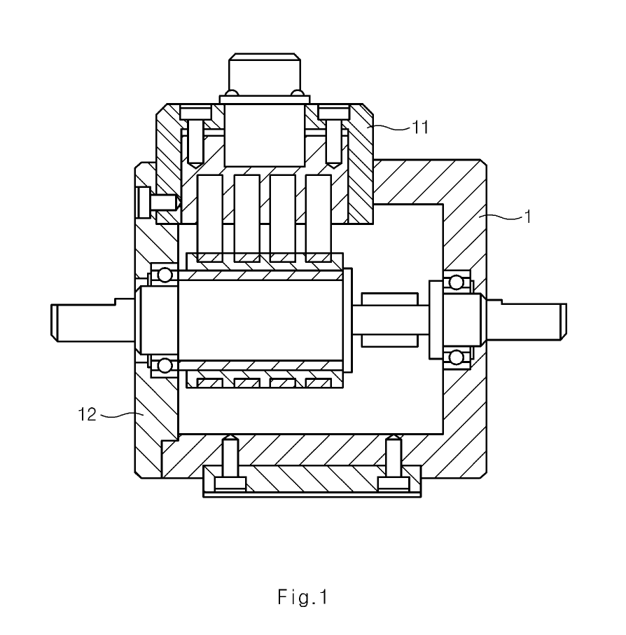

FIG. 2 is a view illustrating a motor having a rotor in an apparatus for measuring torque of a motor according to embodiments of the present disclosure;

FIG. 3 is a cross-sectional view illustrating an apparatus for measuring torque of a motor according to embodiments of the present disclosure;

FIG. 4 is a cross-sectional view illustrating a coupling relationship between a housing case and a shaft in the apparatus for measuring torque of a motor according to embodiments of the present disclosure;

FIG. 5 is a cross-sectional view illustrating the housing case of the apparatus for measuring torque of a motor according to embodiments of the present disclosure;

FIG. 6 is a view illustrating the housing case of the apparatus for measuring torque of a motor according to embodiments of the present disclosure;

FIG. 7 is a graph illustrating torque measured by the apparatus for measuring torque of a motor according to embodiments of the present disclosure; and

FIG. 8 is a graph illustrating fluctuation of torque measured by the apparatus for measuring torque of a motor according to embodiments of the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Hereinafter, embodiments of the present disclosure will be described in detail with reference to the accompanying drawings.

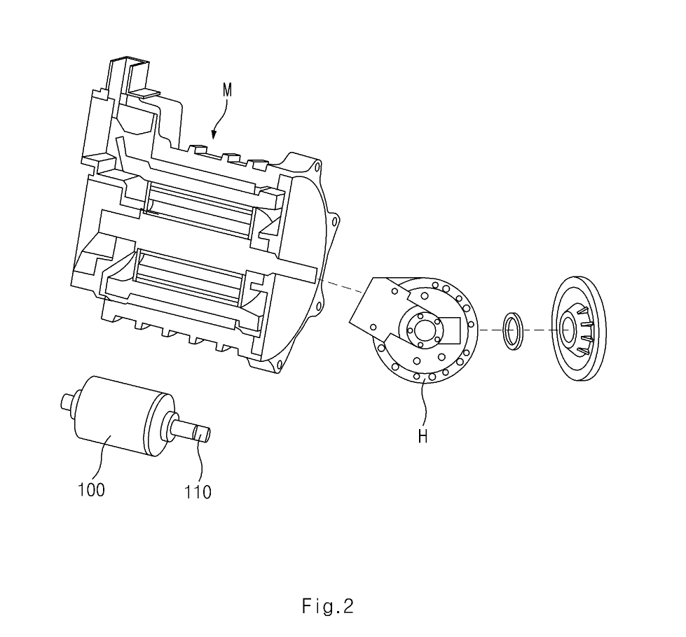

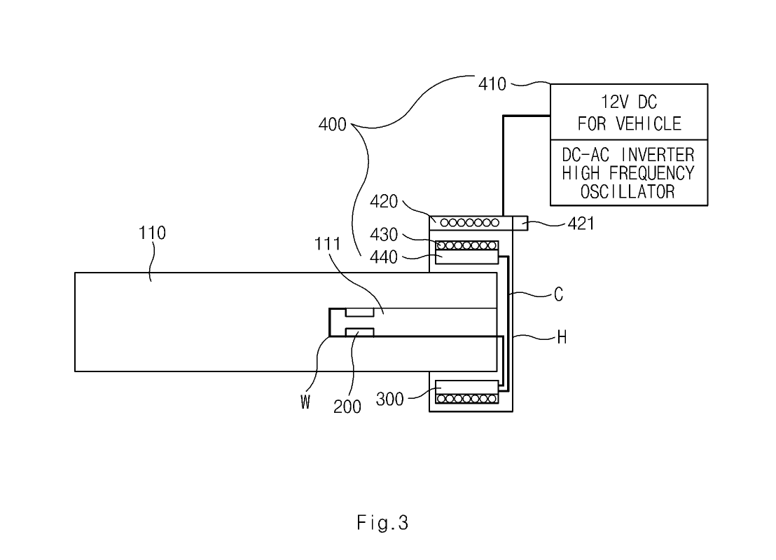

As illustrated in FIGS. 2 and 3, an apparatus for measuring torque of a motor according to an exemplary embodiment of the present disclosure includes a shaft 110 provided in a rotor within a motor M, a strain gauge 200 provided in the shaft 110 and measuring torque of the motor M, a transmitter 300 in communication with the strain gauge 200, and a receiver 400 in communication with the transmitter 300 to receive power.

As illustrated in FIG. 2, the rotor 100 is rotatably inserted within the motor M to generate rotary power in the motor M. Here, the shaft 110 having an opening 111 is inserted into the center of the rotor 100 in a penetrating manner, and an end of the shaft 110 is connected to an extra component to transmit rotary power of the motor M through the shaft 110. A depth of the opening 111 formed in the shaft 110 may be set according to the strength of the shaft 110.

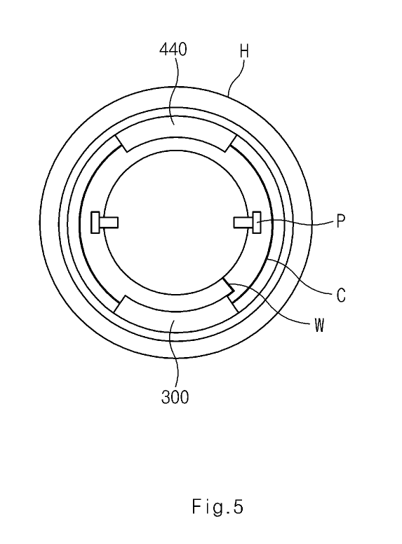

As illustrated in FIGS. 3 through 5, the strain gauge 200, which serves to measure torque of the motor M, is inserted into the opening 111 of the shaft 110 and measures torque when the shaft 110 rotates due to an operation of the motor M. The transmitter 300 is provided in one end of the shaft 110 having the opening 111 formed therein and is in communication with the strain gauge 200 to transmit torque information measured by the strain gauge 200 to the receiver 400, as described hereinafter. The strain gauge 200 and the transmitter 300 may be connected via a wire.

The receiver 400 is in communication with the transmitter 300 and receives power from a vehicle. The transmitter 300 and the receiver 400 are inserted into a housing case H of the motor M. The transmitter 300 is provided in one end of the housing case H, and the receiver 400 is provided in the other end of the housing case H, such that collision may not occur when torque information is transmitted and received.

As illustrated in FIG. 3, the receiver 400 includes a power supply 410 supplying power from a vehicle, a first coil 420 connected to the power supply 410 and generating a magnetic field, a second coil 430 spaced apart from the first coil by a predetermined distance and generating an induced electromotive force, and a rectifier and regulator 440 connected to the second coil 430 and stably supplying a voltage. The first coil 420 and the second coil 430 are formed of a magnet wire. The numbers of turns of the first coil 420 and the second coil 430 determine an inductance value, depending on a diameter of the shaft 110 to be installed in the apparatus for measuring torque of the motor M. As is known in the art, inductance is the property that generates an induced electromotive force, e.g., in a coil, or the like, by a change in a current.

The transmitter 300 and the rectifier and regulator 440 may be connected via a cable C, and rectified power may be supplied to the transmitter 300. The power supply 410 may supply 12V DC power, and here, tens to hundreds of DC high voltage is converted into high voltage AC power by a DC-AC inverter and a high frequency oscillator additionally provided between the power supply 410 and the receiver 400. Preferably, a reception antenna 421 sensing power supplied from the power supply 410 is provided in the first coil 420.

The first coil 420 and the second coil 430 may be spaced apart from one another by a distance ranging from approximately 1 to 3 mm, such that an induced electromotive force is generated in the second coil 430 through a magnetic field generated in the first coil 420 when power is supplied. When the first coil 420 and the second coil 430 are close in proximity, a magnetic field is changed, and at this time, DC power is converted into AC power through the power supply 410 of the vehicle. The AC power can be applied to the first coil 420, the first coil 420 generates a magnetic field using the power, and an induced electromotive force is thereby generated in the second coil 430. Then, the AC power induced to the second coil 430 is converted into DC power through the rectifier and regulator 440, and the converted DC power is supplied to the transmitter 300, thereby wirelessly transmitting the measured signal.

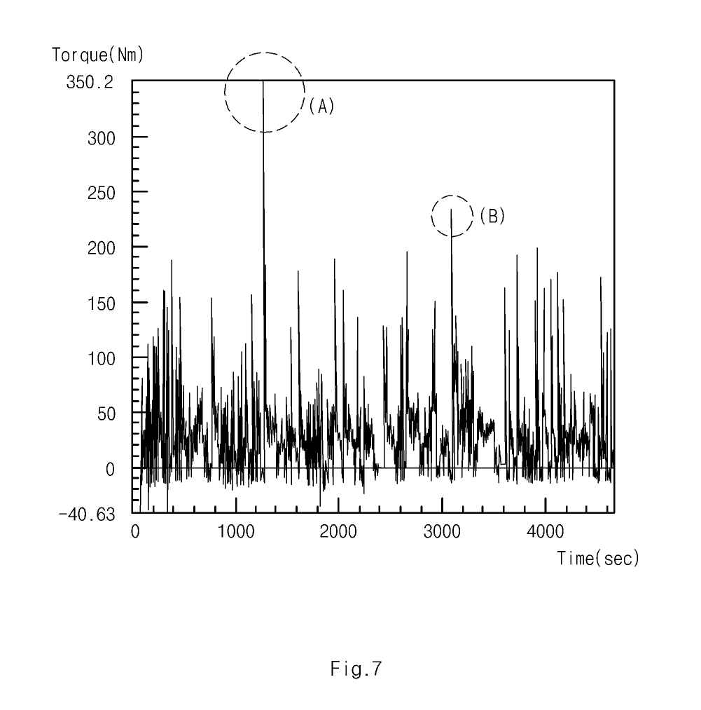

Also, in embodiments of the present disclosure, the strain gauge 200 is provided to enhance maximum torque at a low temperature and a high temperature to maximize temperature compensation. As a result, even a reaction force based on driving/slip variations of the drive shaft 110 as illustrated in FIG. 7, as well as the torque according to the motor (M) output, is transmitted while the vehicle is running, enabling measurement of actual torque applied to the shaft 110 of the rotor 100 of the actual motor M. Thus, a lifespan of the motor M and various test specifications may be accurately established.

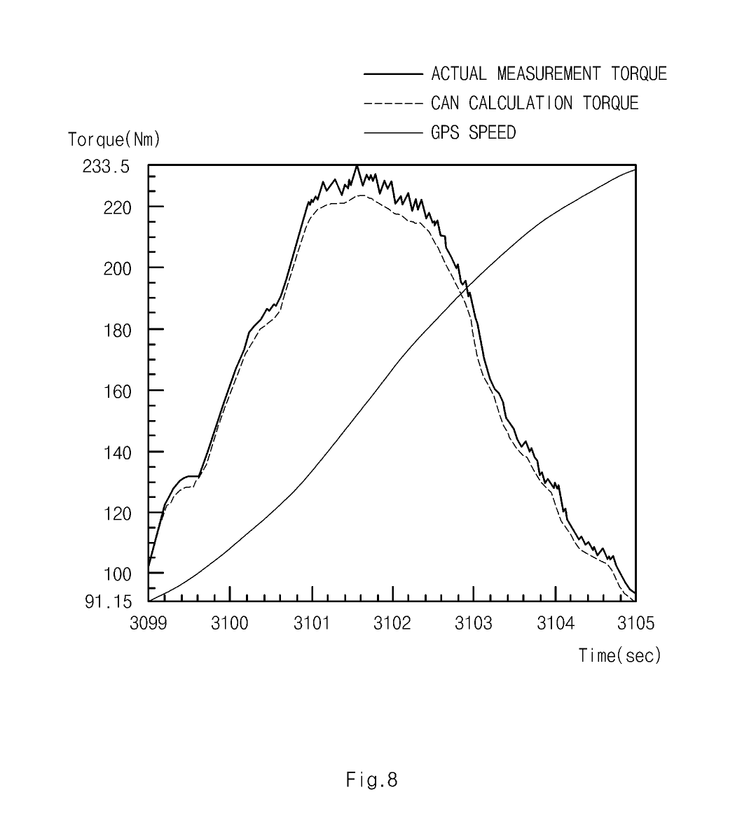

Also, as illustrated in FIG. 8, a controller area network (CAN) signal that is measurable in a vehicle may represent calculated torque, e.g., a voltage/current, or the like, applied as torque of the motor M. However, actual torque is engaged with a gear of a decelerator (e.g., in case of an electric vehicle or a fuel cell vehicle) or a transmission (e.g., in case of a hybrid vehicle), thereby generating fluctuated torque. Since the fluctuated torque component can be measured as is, it can be utilized as data useful for designing the motor M and improving of performance.

The housing case H is formed of fiberglass-cloth with a flame-retardant resin having excellent strength, low water absorption, and excellent electrical insulating characteristics even under dry/humidity condition. The housing case H includes a T-shaped fixing pin P, and the housing case H is fixed to the shaft 110 using the T-shaped fixing pin P, whereby even when the motor M rotates at a high speed (e.g., 10,000 rpm), the housing case H and the shaft 110 can rotate integrally.

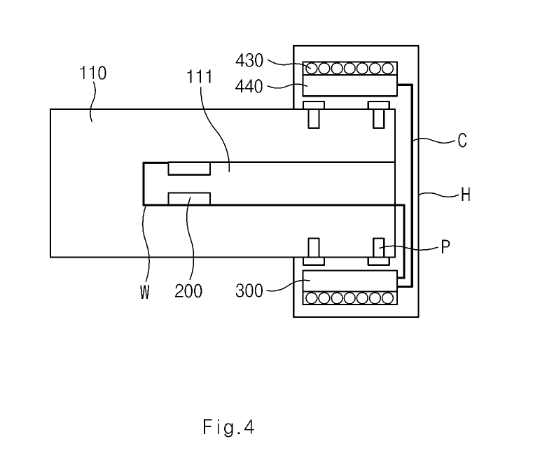

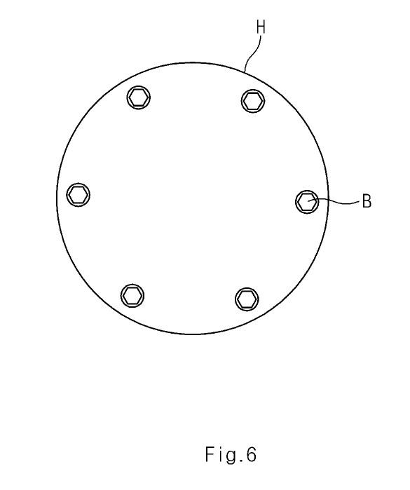

As illustrated in FIGS. 4 through 6, the housing case H has an O-ring rubber seal (not shown) and is assembled using a hexagonal bolt B to prevent a foreign object, dust, and the like, from being introduced to an interior of the housing case H. If necessary, the O-ring rubber seal may be separated to facilitate repair.

In this manner, according to embodiments of the present disclosure, the strain gauge 200 for measuring torque is provided in the opening 111 of the shaft 110 provided in the rotor 100 within the motor M. The transmitter 300 is in communication with the strain gauge 200, and the receiver 400 is in communication with the transmitter 300 and configured to receive power from a vehicle, which enable accurate torque measurements of the electric motor M for a vehicle. Thus, a lifespan of the shaft 110 of the motor M may be accurately estimated, and the running stability and marketability of the motor M may be enhanced. Also, power may be transmitted and received wirelessly to reduce noise generation, thus minimizing fault generation.

The present disclosure described above may be variously substituted, altered, and modified by those skilled in the art to which the present disclosure pertains without departing from the scope and spirit of the present disclosure. Therefore, the present disclosure is not limited to the above-mentioned embodiments and the accompanying drawings.

What is claimed is:

1. An apparatus for measuring torque of a motor, the apparatus comprising:
a shaft provided in a rotor of the motor and having an opening;
a strain gauge inserted into the opening of the shaft and configured to measure torque of the motor;
a transmitter configured to transmit a signal from the strain gauge and receive power formed by electromagnetic induction; and
a receiver configured to receive power from a vehicle to generate electromagnetic induction.

2. The apparatus according to claim 1, wherein the strain gauge and the transmitter are connected via a wire.

3. The apparatus according to claim 1, wherein the transmitter and the receiver are inserted in a housing case of the motor.

4. The apparatus according to claim 3, wherein the transmitter is provided in one end of the housing case, and the receiver is provided in the other end of the housing case.

5. The apparatus according to claim 1, wherein the receiver includes:
a power supply configured to supply power from the vehicle;
a first coil connected to the power supply and configured to generate a magnetic field;
a second coil spaced apart from the first coil by a predetermined distance and configured to generate an induced electromotive force; and
a rectifier and regulator connected to the second coil and configured to supply a voltage.

6. The apparatus according to claim 5, wherein the transmitter and the rectifier and regulator are connected via a cable, allowing rectified power to be supplied to the transmitter.

7. The apparatus according to claim 5, wherein the first coil has a reception antenna configured to sense power supplied from the power supply.

8. The apparatus according to claim 5, wherein the first coil and the second coil are spaced apart from one another by a distance ranging from approximately 1 to 3 mm.

9. The apparatus according to claim 3, wherein the housing case is coupled to the shaft using a T-shaped fixing pin.

10. The apparatus according to claim 9, wherein the housing case has an O-ring rubber seal and is assembled using a hexagonal bolt.

11. An apparatus for measuring torque of a motor, the apparatus comprising:
a shaft provided in a rotor of the motor and having an opening;
a strain gauge inserted into the opening of the shaft and configured to measure torque of the motor;
a transmitter in communication with the strain gauge and connected to the strain gauge via a wire; and
a receiver in communication with the transmitter and including i) a power supply configured to supply power from a vehicle, ii) a first coil connected to the power supply and configured to generate a magnetic field, iii) a second coil spaced apart from the first coil by a predetermined distance and configured to generate an induced electromotive force, and iv) a rectifier and regulator connected to the second coil and configured to supply a voltage.
